(19) United States
(12) Patent Application Publication
(10) Pub. No.: US 2022/0305534 A1
(43) Pub. Date: Sep. 29, 2022

(54) AUTOMATIC CLEANER

(71) Applicant: CHANGXIN MEMORY TECHNOLOGIES, INC., Hefei City, Anhui Province (CN)

(72) Inventors: Cheng WANG, Hefei (CN); Chin-Chung KU, Hefei (CN)

(73) Assignee: CHANGXIN MEMORY TECHNOLOGIES, INC., Hefei City, Anhui Province (CN)

(21) Appl. No.: 17/430,792

(22) PCT Filed: Feb. 8, 2021
(86) PCT No.: PCT/CN2021/076094

§ 371 Date: Aug. 13, 2021

(30) Foreign Application Priority Data
Feb. 20, 2020 (CN) 202010104593.1

(51) Int. Cl. B08B 9/093; B08B 13/00; B08B 9/08

(52) U.S. Cl. CPC B08B 9/093; B08B 13/00; B08B 9/0821; B08B 2209/08

(57) ABSTRACT

In the present application, the automatic cleaner comprises a housing, a first pipeline for extracting liquid from a bucket to be cleaned, and a second pipeline for injecting detergent into the bucket to be cleaned; the first pipeline and the second pipeline are both disposed on an inner wall of the housing, and the housing is configured to be enclosed to form a receiving space for receiving the bucket to be cleaned.

### CROSS-REFERENCE TO RELATED APPLICATIONS

The present application is a national stage application of International Patent Application No. PCT/CN2021/076094, filed on Feb. 8, 2021, which claims priority to Chinese Patent Application No. 202010104593.1, filed on Feb. 20, 2020. The entire contents of the aforementioned patent applications are incorporated herein by reference.

### TECHNICAL FIELD

Embodiments of the present application relate to the technical field of electronic devices, and particularly to an automatic cleaner.

### BACKGROUND

Strong acid or strong base and toxic substances are frequently used in the field of industrial manufacturing, and it becomes a technical task as how to clean the buckets that hold such substances. For instance, milling fluid is the most important consumable material in chemical-mechanical polishing technique, and it is a difficult task faced by semiconductor industry to clean milling fluid buckets and reduce harm thereof. In the state of the art, it is required to manually clean the buckets and spill waste liquid during download treatment and the process of using milling fluid buckets.

As found by the inventor, at least the following problem exists in the prior-art technology, i.e., due to the presence of strong acid or strong base and toxic substances in some of the milling fluid, there would be harm done to the operating personnel in the case of mishandle during the cleaning process.

### SUMMARY

An objective of the embodiments of the present application is to provide an automatic cleaner that makes it possible to prevent residual liquid in the bucket to be cleaned from hurting operating personnel during the cleaning process, thus enhancing safety.

In order to solve the aforementioned technical problem, embodiments of the present application propose an automatic cleaner that comprises a housing, a first pipeline for extracting liquid from a bucket to be cleaned, and a second pipeline for injecting detergent into the bucket to be cleaned; the first pipeline and the second pipeline are both disposed on an inner wall of the housing, and the housing is configured to be enclosed to form a receiving space for receiving the bucket to be cleaned.

### BRIEF DESCRIPTION OF DRAWINGS

FIG. 1 is a schematic view illustrating the structure of the automatic cleaner provided by the embodiment of the present application;

FIG. 2 is a schematic view illustrating the structure of the first sensor provided by the embodiment of the present application;

FIG. 3 is a schematic view illustrating the structure of the second sensor provided by the embodiment of the present application;

FIG. 4 is a schematic view illustrating the structure of the man-machine interface provided by the embodiment of the present application;

FIG. 5 is a schematic view illustrating the structure of the automatic cleaner provided by the embodiment of the present application;

FIG. 6 is a schematic view illustrating the structure of the suction head provided by the embodiment of the present application; and

FIG. 7 is a schematic view illustrating the structure of the bearing plate provided by the embodiment of the present application.

### DESCRIPTION OF EMBODIMENTS

In order to make clearer the objectives, technical solutions and advantages of the present application, detailed and complete explanations are made below to the various embodiments of the present application in combination with the accompanying drawings. Apparently, the embodiments thus explained are merely partial, rather than entire, embodiments of the present application. Other embodiments obtained by persons ordinarily skilled in the art on the basis of the embodiments in the present application without making creative effort shall all fall within the protection scope of the present application.

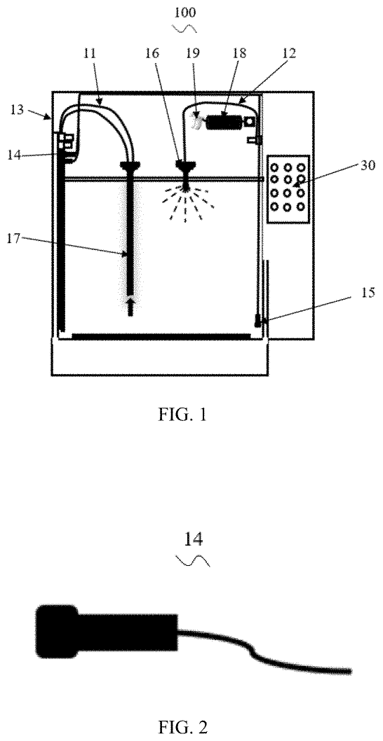

An embodiment of the application provides an automatic cleaner 100, as shown in FIGS. 1 to 3, which comprises a housing 13, a first pipeline 11 for extracting liquid from a bucket to be cleaned, and a second pipeline 12 for injecting detergent into the bucket to be cleaned; the first pipeline 11 and the second pipeline 12 are both disposed on an inner wall of the housing 13, and the housing 13 is configured to be enclosed to form a receiving space for receiving the bucket to be cleaned.

In this embodiment, the automatic cleaner 100 further comprises a first sensor 14 for detecting whether there is liquid in the first pipeline 11, and the first sensor 14 is connected with the first pipeline 11. Such configuration makes it possible to judge whether the liquid in the bucket to be cleaned has been exhausted by detecting whether there is liquid in the first pipeline 11, so that it is possible, when the liquid in the bucket to be cleaned has not been exhausted, to further extract the liquid from the bucket to be cleaned, and to automatically stop the extraction pump connected with the first pipeline 11 when the liquid in the bucket to be cleaned is exhausted, thereby realizing automatic extraction of liquid by the first pipeline 11.

Specifically, the extraction pump connected with the first pipeline 11 is a pneumatic diaphragm pump for driving the first pipeline 11 to extract liquid in the bucket to be cleaned.

When a bucket to be cleaned is placed inside the automatic cleaner 100 for cleaning, the bucket to be cleaned is located inside the receiving space, the end of the first pipeline 11 and the end of the second pipeline 12 are both located in the bucket to be cleaned, pump-power extraction of water is performed via the first pipeline 11 after the bucket to be cleaned is in the operative position, the first sensor 14 is effected to detect whether there is liquid in the first pipeline 11 so as to judge whether residual liquid has been exhausted from the bucket to be cleaned, the residual liquid is then exhausted and water is automatically infused to clean the bucket wall, and residual liquid is subsequently again exhausted—the process is repeated twice to achieve effective cleaning of the bucket to be cleaned.

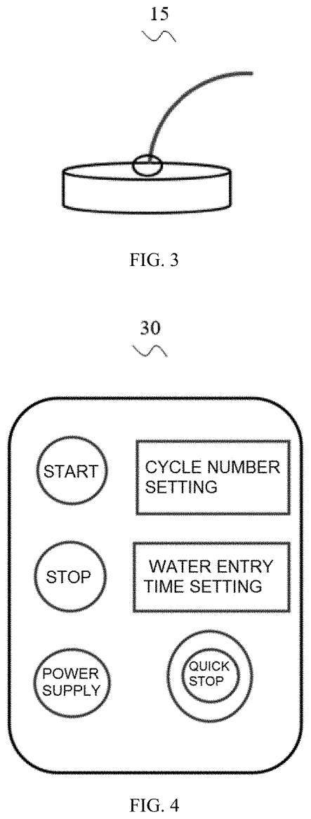

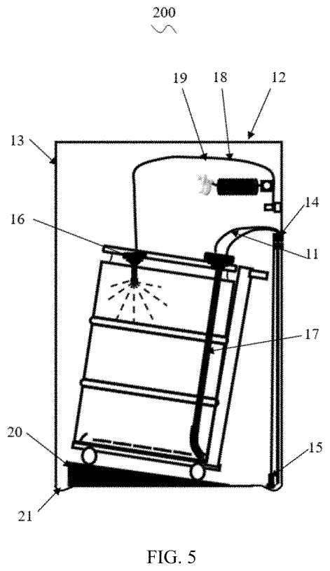

In actual application, the automatic cleaner 100 may further comprise a PLC controller to effect control of the aforementioned process; as shown in FIG. 4, the automatic cleaner 100 may further comprise a man-machine interface 30 tele-communicably connected with the PLC controller, and the man-machine interface 30 comprises power supply, start, stop, quick stop, cycle number setting, water entry time setting, etc.

Specifically, the operating personnel well puts on protective articles and then places the previously down-loaded bucket to be cleaned onto a trolley, pushes the trolley to the automatic cleaner 100 for fixation, places the first pipeline 11 and the second pipeline 12 inside the bucket to be cleaned according to standard, operates the automatic cleaner 100 by pressing “START” button to perform automatic cleaning, and pushes the bucket to be cleaned to a temporary storage area after the bucket has been automatically and completely cleaned.

As it is worth mentioning, the automatic cleaner 100 can further comprise a second sensor 15 for detecting whether liquid in the bucket to be cleaned outflows, the second sensor 15 is disposed on the inner wall of the housing 13, when the bucket to be cleaned is placed in the automatic cleaner 100 for cleaning, the second sensor 15 is located outside the bucket to be cleaned; such configuration makes it possible to judge whether the bucket to be cleaned has been broken by detecting whether liquid exists outside the bucket to be cleaned, once the bucket to be cleaned has been broken, liquid leaked from the bucket to be cleaned into the automatic cleaner 100 is timely cleaned, and this bucket to be cleaned is labeled as “broken”, thereby preventing strong acid or strong base and toxic residual liquid due to breakage of the bucket to be cleaned from contaminating the machine or hurting the operating personnel.

Specifically, the second pipeline 12 is provided with a sprinkler 16 at an end thereof, the first pipeline 11 is provided with a suction head 17 at an end thereof, an automatic program is employed to control the sprinkler 16 to make 360o rotation to clean the milling fluid bucket, whereby is guaranteed complete processing of waste liquid, and an automatic program is employed to control the suction head 17 to extract liquid from the bucket to be cleaned, whereby is enhanced the cleaning efficiency of the automatic cleaner 100. In this embodiment, the automatic cleaner 100 can further comprise a third pipeline 18 disposed on the inner wall of the housing 13, and the third pipeline 18 is provided with a squirt gun 19 at an end thereof; by such configuration, the squirt gun 19 can be manually handled to fully clean some residues, and to clean locations that are relatively difficult to reach—for instance, the conjunction between the bottom wall and the sidewall of the bucket to be cleaned that is difficult for the sprinkler 16 to clean (i.e., the location at the edge of the bottom wall and the lower edge of the sidewall), thereby enhancing cleaning efficiency of the automatic cleaner 100.

As compared by the embodiments of the present application with prior-art technology, since the claimed automatic cleaner comprises a first pipeline 11 for extracting liquid from a bucket to be cleaned, and a second pipeline 12 for injecting detergent into the bucket to be cleaned, expel of residual liquid from the bucket to be cleaned is realized through the first pipeline 11, injection of detergent is effected through the second pipeline 12 for cleaning the bucket to be cleaned, and thereafter automatic expel of the detergent after cleaning is again effected through the first pipeline 11, thus dispensing with the need to manually dump residual liquid from the bucket to be cleaned, thereby preventing residual liquid in the bucket to be cleaned from hurting operating personnel during manually-dumping process, and hence enhancing safety. Moreover, as there is great amount of milling fluid buckets daily engendered during batch production (by estimation according to productive capacity, when the capacity is 125K, 1412 milling fluid buckets to be cleaned would be monthly engendered), it is both time consuming and manpower intensive to manually clean milling fluid buckets, and great amount of manpower cost is required; consequently, it is possible to reduce the burden of engineers and to reduce manpower cost by making use of the cleaner to quickly clean milling fluid buckets.

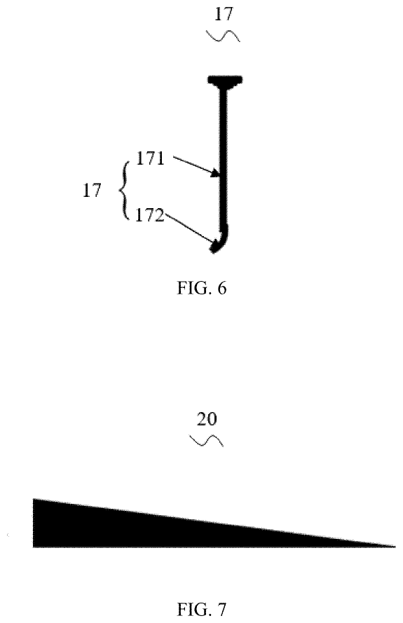

An embodiment of the present application also relates to an automatic cleaner 200, as illustrated in FIGS. 5 through 7; this embodiment is substantially the same as the foregoing embodiment, while differs from the latter mainly in the following: in the present embodiment, the automatic cleaner 200 further comprises a bearing plate 20 disposed at the bottom of the housing 13, and the bearing plate 20 is employed to raise one side of the bucket to be cleaned. By such configuration, liquid in the bucket to be cleaned concentrates onto the lower side of the bucket to be cleaned, thus facilitating the first pipeline 11 to thoroughly extract the liquid in the bucket to be cleaned, and enhancing cleaning efficiency of the automatic cleaner 200.

In actual application, the bearing plate 20 can be disposed only at one side of the bottom of the bucket to be cleaned, in which case the bearing plate 20 can be randomly shaped to raise one side of the bucket to be cleaned.

Of course, the bearing plate 20 can also be disposed at the entire bottom of the bucket to be cleaned, in which case thickness at one side of the bearing plate 20 should be higher than thickness at another side thereof, as it is only thus possible to raise one side of the bucket to be cleaned. In the present embodiment, the bearing plate 20 progressively decreases in thickness along a first direction, whereby it is not only possible to raise one side of the bucket to be cleaned, but also possible to facilitate the trolley to push the bucket to be cleaned into the automatic cleaner 200.

In this embodiment, the automatic cleaner further comprises a base plate, on which the bearing plate 20 is located, and the base plate is provided thereon with a recession 21, right above which the second sensor 15 is located; further, the recession 21 is located at an edge location of the base plate, and of course, the recession 21 can also be located at the middle location of the base plate, to which no restriction is made in this context. By such configuration, liquid outflowing from the bucket to be cleaned would concentrate at the recession 21, thus facilitating the second sensor 15 to detect whether there is liquid outflowing from the bucket to be cleaned.

As it is worth mentioning, in another embodiment the base plate can also not be provided with a recession 21 thereon, whereas the bearing plate 20, the base plate and the sidewall of the housing 13 are utilized to together form a basin-shaped recession, and it suffices to dispose the second sensor 15 above the base plate and near the side of the bearing plate 20 with lesser thickness.

Optionally, in this embodiment, the suction head 17 comprises a body part 171, and an extension part 172 extending in a bending manner from the body part 171 toward a direction approaching the sidewall of the housing 13. As found by the inventor, residual liquid would be usually left at the edge of the bottom wall of the automatic cleaner 200, accordingly, when a bucket to be cleaned is placed in the automatic cleaner 200 for cleaning, the extension part 172 extending in a bending manner toward a direction approaching the sidewall of the housing 13 can reach in the edge of the bottom wall of the automatic cleaner 200, thus facilitating better and thorough extraction of liquid from the bucket to be cleaned.

As compared by the embodiments of the present application with prior-art technology, since the claimed automatic cleaner comprises a first pipeline 11 for extracting liquid from a bucket to be cleaned, and a second pipeline 12 for injecting detergent into the bucket to be cleaned, expel of residual liquid from the bucket to be cleaned is realized through the first pipeline 11, injection of detergent is effected through the second pipeline 12 for cleaning the bucket to be cleaned, and thereafter automatic expel of the detergent after cleaning is again effected through the first pipeline 11, thus dispensing with the need to manually dump residual liquid from the bucket to be cleaned, thereby preventing residual liquid in the bucket to be cleaned from hurting operating personnel during manually-dumping process, and hence enhancing safety. Moreover, as there is great amount of milling fluid buckets daily engendered during batch production (by estimation according to productive capacity, when the capacity is 125K, 1412 milling fluid buckets to be cleaned would be monthly engendered), it is both time consuming and manpower intensive to manually clean milling fluid buckets, and great amount of manpower cost is required; consequently, it is possible to reduce the burden of engineers and to reduce manpower cost by making use of the cleaner to quickly clean milling fluid buckets. At the same time, since the automatic cleaner 200 further comprises a bearing plate 20 disposed at the bottom of the housing 13, and the bearing plate 20 is employed to raise one side of the bucket to be cleaned, liquid in the bucket to be cleaned concentrates onto the lower side of the bucket to be cleaned, thus facilitating the first pipeline 11 to thoroughly extract the liquid in the bucket to be cleaned, and enhancing cleaning efficiency of the automatic cleaner 200. Furthermore, since the suction head 17 comprises a body part 171, and an extension part 172 extending in a bending manner from the body part 171 toward a direction approaching the sidewall of the housing 13, when a bucket to be cleaned is placed in the automatic cleaner 200 for cleaning, the extension part 172 can reach in the edge of the bottom wall of the automatic cleaner 200, thus facilitating better and thorough extraction of liquid from the bucket to be cleaned.

As understandable to persons ordinarily skilled in the art, the aforementioned various embodiments are specific embodiments that realize the present application, while various modifications capably made thereto both in form and in detail during actual application, such as a combination of two or more embodiments, shall not be regarded as departing from the principle and scope of the present application.

What is claimed is:

1. An automatic cleaner, comprising: a housing, a first pipeline for extracting liquid from a bucket to be cleaned, and a second pipeline for injecting detergent into the bucket to be cleaned, wherein the first pipeline and the second pipeline are both disposed on an inner wall of the housing, and the housing is configured to be enclosed to form a receiving space for receiving the bucket to be cleaned.

2. The automatic cleaner according to claim 1, wherein the automatic cleaner further comprises a first sensor for detecting whether there is liquid in the first pipeline, the first sensor being connected to the first pipeline.

3. The automatic cleaner according to claim 1, wherein the automatic cleaner further comprises a bearing plate disposed at the bottom of the housing, the bearing plate being for raising one side of the bucket to be cleaned.

4. The automatic cleaner according to claim 3, wherein the bearing plate progressively decreases in thickness along a first direction.

5. The automatic cleaner according to claim 1, wherein the automatic cleaner further comprises a second sensor for detecting whether liquid in the bucket to be cleaned outflows, the second sensor being disposed on the inner wall of the housing.

6. The automatic cleaner according to claim 5, wherein the automatic cleaner further comprises a base plate bearing the bucket to be cleaned, the base plate being provided thereon with a recession, right above which the second sensor is located.

7. The automatic cleaner according to claim 1, wherein the first pipeline is provided with a suction head at an end thereof, the suction head comprising a body part, and an extension part extending in a bending manner from the body part toward a direction approaching a sidewall of the housing.

8. The automatic cleaner according to claim 1, wherein the second pipeline is provided with a sprinkler at an end thereof.

9. The automatic cleaner according to claim 1, wherein the automatic cleaner further comprises a third pipeline disposed on the inner wall of the housing, the third pipeline being provided with a squirt gun at an end thereof.

10. The automatic cleaner according to claim 1, wherein the automatic cleaner further comprises a pneumatic diaphragm pump connected with the first pipeline, the pneumatic diaphragm pump being for driving the first pipeline to extract liquid in the bucket to be cleaned.
